(19) United States
(12) Patent Application Publication
(10) Pub. No.: US 2023/0415597 A1
(43) Pub. Date: Dec. 28, 2023

(54) SYSTEM AND METHOD FOR INSTALLING CHARGING DISPENSERS FOR AN ELECTRIC VEHICLE

(71) Applicant: Oldcastle Infrastructure, Inc., Atlanta, GA (US)

(72) Inventors: Ross Jette, Atlanta, GA (US); Kailey Russell, Atlanta, GA (US); Jeff S. Zager, Atlanta, GA (US); Greg Isaacson, Atlanta, GA (US)

(21) Appl. No.: 18/340,646

(22) Filed: Jun. 23, 2023

Related U.S. Application Data
(60) Provisional application No. 63/355,502, filed on Jun. 24, 2022.

(51) Int. Cl. B60L 53/31

(52) U.S. Cl. CPC B60L 53/31

(57) ABSTRACT

A system and method for installing charging dispensers for an electric vehicle includes a first anchor plate removably interconnected with a lid of a utility box or a base at a predetermined location, and replaceable with a second anchor plate at the predetermined location. The first anchor plate and the second anchor plate couple to the lid or base in a uniform configuration, and the first anchor plate and the second anchor plate have different mounting patterns corresponding to different first and second charging dispensers. The lid is removably interconnected to an enclosure of the utility box. Electrical components may be routed to and from the charging dispenser via electrical apertures in the anchor plate and the lid or the base.

### CROSS-REFERENCE TO RELATED APPLICATIONS

The present application claims priority to U.S. Provisional Application No. 63/355,502, filed on Jun. 24, 2022, and entitled “SYSTEM AND METHOD FOR INSTALLING CHARGING DISPENSERS FOR AN ELECTRIC VEHICLE,” which is hereby incorporated by reference in the entirety.

### FIELD

The present disclosure generally relates to a system and method for installing charging dispensers for an electric vehicle (“EV”). More specifically, the present disclosure relates to a dispenser anchor plate and methods for installing the same, where the anchor plate allows for the coupling of different charging dispenser configurations to a surface.

### BACKGROUND

The electric vehicle (“EV”) charging infrastructure includes a centralized power grid and/or standalone power generators coupled to charging dispensers (also called “charging stations”). The EV charging infrastructure is becoming increasingly larger worldwide, with thousands of new charging dispensers being installed every year. Multiple companies manufacture charging dispensers, resulting in numerous different designs or configurations for the charging dispensers in terms of parameters such as size, shape, and weight. The differences in the designs or configurations for the charging dispensers have caused non-uniform solutions for mounting the charging dispensers to a surface such as a platform or pad installed on or in a ground surface.

Utility boxes are used to install infrastructure (e.g., power grid, water, sewer, gas, or the like). Select utility boxes include an enclosure with an opening at the top. A lid or cap is coupled to or inserted in the enclosure, and is configured to provide access to a cavity defined within the enclosure. The lid may be fully operably or removably interconnected for access to the cavity, or at least a portion of the lid may be operably or removably interconnected for access to the cavity while the remainder is affixed to the enclosure. The utility box may be at least partially buried within a ground surface (e.g., as subgrade infrastructure). For example, a portion of the enclosure and the entire lid may be exposed above the ground surface. By way of another example, a portion of the lid may be exposed above the ground surface, and the entire enclosure may be buried within the ground surface. For instance, a top surface of the lid may be exposed and flush to grade, while the remainder of the lid and the enclosure is buried within the ground surface.

Changing charging dispensers or utility boxes currently requires the excavation of old mounting structures such as the mounting plate for the old charging dispenser or the enclosure of the utility box, and subsequent modification of the excavated hole to accept new mounting structures such as the new charging dispenser mounting plate or enclosure of the new utility box. This modification may include resizing one or more dimensions of the hole, pouring a new foundation or slab, rewiring electrical leads to the charging dispenser, and other procedures that require considerable time and expense.

### SUMMARY

Accordingly, there is a need for a system and method for providing a uniform solution for installing charging dispensers for an electric vehicle. The system and method should include an apparatus that is operably or removably interconnected with a utility box sitting on a ground surface or buried at least partly within the ground surface. The apparatus should be swappable or interchangeable with another apparatus with a different configuration when a charging dispenser is removed from the EV charging infrastructure and a different charging dispenser with a different configuration or design is installed within the EV charging infrastructure. Every configuration of the apparatus should be operably or removably interconnected with the same utility box through uniform connections between each configuration of the apparatus and the utility box.

It is one aspect of the present disclosure to provide a system and method for installing charging dispensers for the electric vehicle, and more specifically to a dispenser anchor plate and methods for installing the same, where the anchor plate allows for the coupling of different charging dispenser configurations to a surface. The anchor plate provides a uniform solution for designing an increasingly modular or retrofittable EV charging infrastructure. Each anchor plate is configured for a particular charging dispenser mounting configuration but is uniform to any utility box. The uniform coupling between the particular charging dispenser mounting configuration and the utility box allows for increased ease when swapping or interchanging charging dispensers as they fail, become obsolete, or are otherwise in need of replacement. In addition, using the utility boxes with the charging dispensers allows for increased ease of retrofitting and broadening of EV charging infrastructure with minimal downtime or construction costs. In this regard, the anchor plate reduces or eliminates the need for excavating old mounting structures for old charging dispensers and modifying the ground surface to accept new mounting structures for new charging dispensers, thus reducing lost time and expenses.

In another aspect of the present disclosure, an anchor plate configured to couple to a lid or cap of a utility box, a base, or a support structure is provided. In some embodiments of the present disclosure, the anchor plate corresponds to a particular dispenser mounting configuration. In various embodiments of the present disclosure, the anchor plate is operably or removably interconnected and/or swappable and/or interchangeable with another anchor plate having a different configuration, where a corresponding charging dispenser is installed or swapped or interchanged with a charging dispenser with a different configuration.

In an example embodiment of the present disclosure, a utility box configured to couple to a charging dispenser includes an enclosure with a plurality of sidewalls defining an enclosure cavity. The charging dispenser includes a lid operably connected to the plurality of sidewalls. The charging dispenser includes a first anchor plate. The first anchor plate includes a first lid mount aperture configured to receive a first lid mount fastener. The first anchor plate is operably or removably interconnected to the lid with the first lid mount fastener at a predetermined location on the lid. The first anchor plate includes a first dispenser fastener. The first dispenser fastener is affixed to the first anchor plate at a location defined by a first mounting pattern of a first charging dispenser. The first charging dispenser is operably or removably interconnected to the first anchor plate via the first dispenser fastener. The first charging dispenser is operably or removably interconnected to the ground surface via the lid and the first anchor plate.

In some embodiments, the utility box includes a second anchor plate. The second anchor plate includes a second lid mount aperture configured to receive the first lid mount fastener. The second anchor plate is operably or removably interconnected to the lid via the first lid mount fastener at the predetermined location on the lid when the first anchor plate is not coupled to the lid. The second anchor plate includes a second dispenser fastener. The second dispenser fastener is affixed to the second anchor plate at a location defined by a second mounting pattern of a second charging dispenser. The second charging dispenser is operably or removably interconnected to the second anchor plate via the second dispenser fastener. The second mounting pattern of the second charging dispenser is different from the first mounting pattern of the first charging dispenser. The second charging dispenser is operably or removably interconnected to the ground surface via the lid and the second anchor plate.

In some embodiments, the enclosure is at least partially insertable within the ground surface. The lid includes at least one lid aperture configured to receive at least one lid fastener. The lid is operably or removably interconnected to the enclosure via the at least one lid fastener.

In some embodiments, the lid includes an electrical aperture. The electrical aperture is configured to allow for the routing of one or more electrical components between a cavity defined within the enclosure and the first charging dispenser when coupled to the lid via the first anchor plate, where the first anchor plate includes a first electrical aperture configured to at least partially overlap with the electrical aperture. The electrical aperture alternatively is configured to allow for the routing of one or more electrical components between the cavity defined within the enclosure and the second charging dispenser when coupled to the lid via the second anchor plate, where the second anchor plate includes a second electrical aperture configured to at least partially overlap with the electrical aperture.

In an example embodiment of the present disclosure, a method for coupling a charging dispenser to a utility box includes coupling a first anchor plate to a lid of the utility box via a first lid mount fastener, where the first lid mount fastener is configured to pass through a first lid mount aperture of the first anchor plate when coupling the first anchor plate to the lid, where the lid is positionable proximate to a ground surface. The method may include, but is not limited to, coupling a first charging dispenser to the first anchor plate via a first dispenser fastener, where the first dispenser fastener is affixed to the first anchor plate at a location defined by a first mounting pattern of the first charging dispenser. The first charging dispenser is operably or removably interconnected to the ground surface via the lid and the first anchor plate.

In some embodiments, the method may include, but is not limited to, coupling a second anchor plate to the lid via a second lid mount fastener when the first anchor plate is not coupled to the lid, where the second lid mount fastener is configured to pass through a second lid mount aperture of the second anchor plate when coupling the second anchor plate to the lid. The method may include, but is not limited to, coupling a second charging dispenser to the first anchor plate via a second dispenser fastener, where the second dispenser fastener is affixed to the second anchor plate at a location defined by a second mounting pattern of the second charging dispenser. The second mounting pattern of the second charging dispenser is different from the first mounting pattern of the first charging dispenser. The second charging dispenser is operably or removably interconnected to the ground surface via the lid and the second anchor plate.

In some embodiments, the first charging dispenser with the first mounting pattern is uncoupled from the first anchor plate and the first anchor plate is uncoupled from the lid prior to the coupling of the second anchor plate to the lid and the coupling of the second charging dispenser with the second mounting pattern to the second anchor plate.

In some embodiments, the method may include, but is not limited to, coupling the lid to an enclosure of the utility box via at least one lid fastener. The at least one lid fastener is configured to pass through at least one lid aperture of the lid when coupling the lid to the enclosure. The enclosure is at least partially insertable within the ground surface.

In some embodiments, the method may include, but is not limited to, routing one or more electrical components from a cavity defined within the enclosure and through an electrical aperture of the lid. The one or more electrical components are routed to the first charging dispenser when coupled to the lid via the first anchor plate, where the first anchor plate includes an electrical plate aperture configured to at least partially overlap with the electrical aperture. Alternatively, the one or more electrical components are routed to the second charging dispenser when coupled to the lid via the second anchor plate, where the second anchor plate includes an electrical plate aperture configured to at least partially overlap with the electrical aperture.

In an example embodiment of the present disclosure, a base configured to couple to an apparatus includes a first anchor plate. The first anchor plate includes a first base mount aperture configured to receive a first base mount fastener. The first anchor plate is operably or removably interconnected to the base with the first base mount fastener at a predetermined location on the base. The first anchor plate includes a first apparatus fastener affixed to the first anchor plate at a location defined by a first mounting pattern of a first apparatus. The first apparatus is operably or removably interconnected to the first anchor plate via the first apparatus fastener. The first apparatus is operably or removably interconnected to the ground surface via the first anchor plate. In some embodiments, the apparatus may include, but is not limited to, electric vehicle (“EV”) charging stations, automatic teller machines (“ATMs”), gas pumps, drive-thru signs and terminals, parking lot ticket kiosks, toll booths, bike or scooter rental kiosks, residential and commercial fixtures such as light poles, bollards, barriers, or cones, and generally any apparatus or device to which a person may walk, ride, or drive.

In some embodiments, the base includes a second anchor plate. The second anchor plate includes a second base mount aperture configured to receive the first base mount fastener. The second anchor plate is operably or removably interconnected to the base with the first base mount fastener at the predetermined location on the base when the first anchor plate is not coupled to the base. The second anchor plate includes a second apparatus fastener. The second apparatus fastener is affixed to the second anchor plate at a location defined by a second mounting pattern of a second apparatus. The second apparatus is operably or removably interconnected to the second anchor plate via the second apparatus fastener. The second mounting pattern of the second apparatus is different from the first mounting pattern of the first apparatus. The second apparatus is operably or removably interconnected to the ground surface via the second anchor plate.

In some embodiments, the base includes an electrical aperture. The electrical aperture is configured to allow for the routing of one or more electrical components from electrical connections routed underneath the base and the first apparatus when coupled to the base via the first anchor plate, where the first anchor plate includes a first electrical aperture configured to at least partially overlap with the electrical aperture. The electrical aperture may alternatively be configured to allow for the routing of one or more electrical components from electrical connections routed underneath the base and the second apparatus when coupled to the base via the second anchor plate, where the second anchor plate includes a second electrical aperture configured to at least partially overlap with the electrical aperture.

In embodiments, a second anchor plate may be coupled to a first anchor plate to modify the first anchor plate to include a second mounting pattern for a second apparatus, such that the first anchor plate as modified with the second mounting pattern can couple to the second apparatus without removal of the first anchor plate. In these embodiments, the second anchor plate may include both the first mounting pattern to couple to the first anchor plate and the second mounting pattern to couple to the second apparatus, in addition to or instead of coupling the second anchor plate to the base mount fastener on the base.

In an example embodiment of the present disclosure, a system for installing charging dispensers for an electric vehicle comprises a utility box and a first anchor plate. The utility box comprises an enclosure including a plurality of sidewalls defining an enclosure cavity, and a lid operably interconnected to the plurality of sidewalls and including a lid mount fastener, wherein at least a portion of one or more of the enclosure and the lid is positioned within a ground surface. The first anchor plate comprises a first lid mount aperture configured to receive the lid mount fastener, the first anchor plate being removably interconnected to the lid at a predetermined location on the lid when the first lid mount aperture receives the lid mount fastener, and a first dispenser fastener at a location on the first anchor plate defined by a first mounting pattern of a first charging dispenser, wherein the first anchor plate is operable to interconnect with the first charging dispenser via the first dispenser fastener. The utility box is operable to interconnect the first charging dispenser to the ground surface via interconnection between the first anchor plate and the lid.

In some embodiments, the lid comprises an electrical lid aperture and the first anchor plate comprises a first electrical plate aperture configured to at least partially overlap with the electrical lid aperture when the first charging dispenser is interconnected to the lid via the first anchor plate. The electrical lid aperture and the first electrical plate aperture are configured to allow for the routing of one or more electrical components between the enclosure cavity and the first charging dispenser when the first charging dispenser is interconnected to the lid via the first anchor plate.

In some embodiments, the system further includes a second anchor plate comprising a second lid mount aperture configured to receive the lid mount fastener, the second anchor plate being removably interconnected to the lid at the predetermined location on the lid when the second lid mount aperture receives the lid mount fastener, and a second dispenser fastener at a location defined by a second mounting pattern of a second charging dispenser, wherein the second anchor plate is operable to interconnect with the second charging dispenser via the second dispenser fastener. The second mounting pattern of the second charging dispenser is different from the first mounting pattern of the first charging dispenser. The utility box is operable to interconnect the second charging dispenser to the ground surface via interconnection between the second anchor plate and the lid.

In some embodiments, the second anchor plate is removably interconnected with the lid at the predetermined location on the lid when the first anchor plate is not interconnected to the lid. In some embodiments, the second anchor plate comprises a second electrical plate aperture configured to at least partially overlap with the electrical lid aperture when the second charging dispenser is interconnected to the lid via the second anchor plate. The electrical lid aperture and the second electrical plate aperture are configured to allow for the routing of one or more electrical components between the enclosure cavity and the second charging dispenser when the second charging dispenser is interconnected to the lid via the second anchor plate.

In some embodiments, the predetermined location for at least one of the first anchor plate and the second anchor plate is on a top surface of the lid. In some embodiments, the top surface of the lid is a first planar surface, and a top plate surface of at least one of the first anchor plate and the second anchor plate is a second planar surface at a different height relative to the ground surface than the first planar surface.

In some embodiments, the lid further includes at least one lid aperture configured to receive at least one lid fastener, the lid being removably interconnected to the enclosure via the interconnection of the at least one lid aperture, the at least one lid fastener, and the enclosure.

In an example embodiment of the present disclosure, a method for installing charging dispensers for an electric vehicle comprises coupling a first anchor plate to a lid of a utility box via a lid mount fastener of the lid at a predetermined location on the lid, the lid mount fastener configured to engage with a first lid mount aperture of the first anchor plate when interconnecting the first anchor plate to the lid, the lid being operably interconnected to a plurality of sidewalls defining an enclosure cavity of an enclosure of the utility box, wherein at least a portion of one or more of the enclosure and the lid is positioned within a ground surface. The method comprises coupling a first charging dispenser to the first anchor plate via a first dispenser fastener of the first anchor plate positioned at a location on the first anchor plate defined by a first mounting pattern of the first charging dispenser. The utility box is operable to interconnect the first charging dispenser to the ground surface via interconnection between the first anchor plate and the lid.

In some embodiments, the method further comprises, when the first charging dispenser is interconnected to the lid via the first anchor plate, routing one or more electrical components from the enclosure cavity through an electrical lid aperture of the lid and a first electrical plate aperture of the first anchor plate configured to at least partially overlap with the electrical lid aperture.

In some embodiments, the method further comprises coupling a second anchor plate to the lid via the lid mount fastener, the lid mount fastener configured to engage with a second lid mount aperture of the second anchor plate when interconnecting the second anchor plate to the lid, and coupling a second charging dispenser to the second anchor plate via a second dispenser fastener of the second anchor plate positioned at a location on the second anchor plate defined by a second mounting pattern of the second charging dispenser. The second mounting pattern of the second charging dispenser is different from the first mounting pattern of the first charging dispenser. The utility box is operable to interconnect the second charging dispenser to the ground surface via interconnection between the second anchor plate and the lid.

In some embodiments, the second anchor plate is removably interconnected with the lid at the predetermined location on the lid when the first anchor plate is not coupled to the lid, and wherein the first charging dispenser is uncoupled from the first anchor plate and the first anchor plate is uncoupled from the lid prior to the coupling of the second anchor plate to the lid and the coupling of the second charging dispenser to the second anchor plate.

In some embodiments, the method further comprises, when the second charging dispenser is interconnected to the lid via the second anchor plate, routing one or more electrical components from the enclosure cavity through an electrical lid aperture of the lid and a second electrical plate aperture of the second anchor plate configured to at least partially overlap with the electrical lid aperture.

In some embodiments, the predetermined location for at least one of the first anchor plate and the second anchor plate is on a top surface of the lid. In some embodiments, the top surface of the lid is a first planar surface, and herein a top plate surface of at least one of the first anchor plate and the second anchor plate is a second planar surface at a different height relative to the ground surface than the first planar surface.

In an example embodiment of the present disclosure, an anchor plate for installing charging dispensers for an electric vehicle comprises a lid mount aperture configured to receive a lid mount fastener, the anchor plate being removably interconnectable to a lid of a utility box at a predetermined location on the lid when the lid mount aperture receives the lid mount fastener, and a dispenser fastener at a location on the anchor plate defined by a mounting pattern of a charging dispenser. The anchor plate is operable to interconnect with the charging dispenser via the dispenser fastener. An interconnection between the anchor plate and the lid interconnects the charging dispenser to the utility box.

In some embodiments, the anchor plate is one of a plurality of interchangeable anchor plates, each of the plurality of anchor plates including a mounting pattern for a particular charging dispenser, and the mounting pattern of the charging dispenser on the anchor plate is different from a second mounting pattern of a second charging dispenser on a second anchor plate of the plurality of interchangeable anchor plates.

In some embodiments, the anchor plate comprises an electrical plate aperture configured to at least partially overlap with an electrical lid aperture in the lid when the charging dispenser is interconnected to the lid to allow for the routing of one or more electrical components between an enclosure cavity defined by a plurality of sidewalls of an enclosure of the utility box and the charging dispenser when the charging dispenser is interconnected to the lid via the anchor plate.

In some embodiments, the predetermined location for the anchor plate is on a top surface of the lid. In some embodiments, the top surface of the lid is a first planar surface, and a top plate surface of at least one of the first anchor plate and the second anchor plate is a second planar surface at a different height relative to the ground surface than the first planar surface.

Examples of utility boxes, utility vaults, other subgrade enclosures, and lids or caps for the like may be found in U.S. Pat. No. 4,863,059, issued Sep. 5, 1989; U.S. Pat. No. 7,163,352, issued Jan. 16, 2007; U.S. Pat. No. 7,748,926, issued Jul. 6, 2010; U.S. Pat. No. 8,061,928, issued Nov. 22, 2011; U.S. Design Pat. No. D662,323, issued Jun. 26, 2012; U.S. Design Pat. No. D654,693, issued Feb. 28, 2012; U.S. Design Patent No. D682,553, issued May 21, 2013; U.S. Pat. No. 8,469,628, issued Jun. 25, 2013; U.S. Pat. No. 8,821,062, issued Sep. 2, 2014; U.S. Pat. No. 8,827,589, issued Sep. 9, 2014; U.S. Pat. No. 8,835,757, issued Sep. 16, 2014; U.S. Pat. No. 9,174,798, issued Nov. 3, 2015; U.S. Pat. No. 9,284,711, issued Mar. 15, 2016; U.S. Pat. No. 9,346,593, issued May 24, 2016; U.S. Pat. No. 9,435,099, issued Sep. 6, 2016; U.S. Pat. No. 9,919,853, issued Mar. 20, 2018; U.S. Pat. No. 9,932,157, issued Apr. 3, 2018; U.S. Pat. No. 10,132,052, issued Nov. 20, 2018; U.S. Pat. No. 10,136,530, issued Nov. 20, 2018; U.S. Pat. No. 10,197,088, issued Feb. 5, 2019; U.S. Design Pat. No. D841,279, issued Feb. 19, 2019; U.S. Pat. No. 10,240,316, issued Mar. 26, 2019; U.S. Pat. No. 10,947,693, issued Mar. 16, 2021; and U.S. Pat. No. 11,066,803, issued Jul. 20, 2021, each of which are incorporated herein in their entireties.

The Summary is neither intended nor should it be construed as being representative of the full extent and scope of the present disclosure. The present disclosure is set forth in various levels of detail in the Summary as well as in the attached drawings and the Detailed Description and no limitation as to the scope of the present disclosure is intended by either the inclusion or non-inclusion of elements, components, etc. in this Summary. Additional aspects of the present disclosure will become more clear from the Detailed Description, particularly when taken together with the drawings.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

The term “a” or “an” entity, as used herein, refers to one or more of that entity. As such, the terms “a” (or “an”), “one or more”, and “at least one” can be used interchangeably herein.

Unless otherwise indicated, all numbers expressing quantities, dimensions, conditions, ratios, ranges, and so forth used in the specification and claims are to be understood as being modified in all instances by the term “about” or “approximately”. Accordingly, unless otherwise indicated, all numbers expressing quantities, dimensions, conditions, ratios, angles, ranges, and so forth used in the specification and claims may be increased or decreased by approximately 5% to achieve satisfactory results. In addition, where the meaning of the terms “about” or “approximately” as used herein would not otherwise be apparent to one of ordinary skill in the art, the terms “about” and “approximately” should be interpreted as meaning within plus or minus 10% of the stated value.

The term “parallel” means two objects are oriented at an angle within plus or minus 0° to unless otherwise indicated. Similarly, the term “perpendicular” means two objects are oriented at angle of from 85° to 95° unless otherwise indicated. Unless otherwise indicated, the term “substantially” indicates a different of from 0% to 5% of the stated value is acceptable. All ranges described herein may be reduced to any sub-range or portion of the range, or to any value within the range without deviating from the invention. For example, the range “5 to 55” includes, but is not limited to, the sub-ranges “5 to 20” as well as “17 to 54.”

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all the equivalents thereof. Further, the structures, materials, or acts and the equivalents thereof shall include all those described in the Summary, Brief Description of the Drawings, Detailed Description, Abstract, and Claims themselves.

Unless otherwise stated, any embodiment described throughout the disclosure should be understood as being individually implementable and/or combinable with any other embodiment or embodiments described throughout the disclosure.

### BRIEF DESCRIPTION OF THE DRAWINGS

The accompanying drawings, which are incorporated in and constitute a part of the specification, illustrate embodiments of the disclosed system and together with the general description of the disclosure given above and the detailed description of the drawings given below, serve to explain the principles of the disclosed system(s) and device(s). In the drawings:

FIG. 1A depicts a system including an example EV charging station or charging dispenser and a utility box, in accordance with one or more embodiments of the present disclosure;

FIG. 1B depicts a system including an example power block and charging dispensers;

FIG. 2 depicts a perspective view of a dispenser anchor plate, in accordance with one or more embodiments of the present disclosure;

FIG. 3 depicts a top plan view of the anchor plate of FIG. 2;

FIG. 4 depicts a bottom plan view of the anchor plate of FIG. 2;

FIG. 5 depicts a side elevation view of the anchor plate of FIG. 2;

FIG. 6 depicts a perspective view of a dispenser anchor plate and a utility box including a lid and enclosure, in accordance with one or more embodiments of the present disclosure;

FIG. 7 depicts a top plan view of the dispenser anchor plate and the utility box with lid and enclosure of FIG. 6;

FIG. 8 depicts a cross-section elevation view taken along cut 8-8 of the dispenser anchor plate and the utility box with lid and enclosure of FIG. 7;

FIG. 9 depicts a perspective view of a dispenser anchor plate and a utility box including a lid and enclosure, in accordance with one or more embodiments of the present disclosure;

FIG. 10 depicts a top plan view of the dispenser anchor plate and the utility box with lid and enclosure of FIG. 9;

FIG. 11 depicts a front elevation view of the dispenser anchor plate and the utility box with lid and enclosure of FIG. 9;

FIG. 12 depicts a side elevation view of the dispenser anchor plate and the utility box with lid and enclosure of FIG. 9;

FIG. 13 depicts a side cross-section view taken along cut 13-13 of the dispenser anchor plate and the utility box with lid and enclosure of FIG. 10;

FIG. 14A depicts a flow diagram including a method or process for installing charging dispensers for an electric vehicle, in accordance with one or more embodiments of the present disclosure;

FIG. 14B depicts a flow diagram including a method or process for installing charging dispensers for an electric vehicle, in accordance with one or more embodiments of the present disclosure; and

FIG. 15 depicts a system for installing charging dispensers for an electric vehicle, in accordance with one or more embodiments of the present disclosure.

The drawings are not necessarily (but may be) to scale. In certain instances, details that are not necessary for an understanding of the disclosure or that render other details difficult to perceive may have been omitted. It should be understood, of course, that the disclosure is not necessarily limited to the embodiments illustrated herein. As will be appreciated, other embodiments are possible using, alone or in combination, one or more of the features set forth above or described below. For example, it is contemplated that various features and devices shown and/or described with respect to one embodiment may be combined with or substituted for features or devices of other embodiments regardless of whether or not such a combination or substitution is specifically shown or described herein.

The following is a listing of components according to various embodiments of the present disclosure, and as shown in the drawings:

| Number | Component |
|---|---|
| 100, 100A, 100B | System |
| 102, 102A, 102B | Charging Dispenser/ |
| | Charging Station/Apparatus |
| 104, 104A, 104B | Dispenser Base |
| 106 | Utility Box |
| 108 | Lid/Cap/Base/Support Structure |
| 110 | Enclosure |
| 112 | Power Block |
| 114 | Power Block Base |
| 116, 116A, 116B | Anchor Plate |
| 118 | Lid Mount Apertures |
| 119 | Lid Mount Fasteners |
| 120 | Top Plate Surface |
| 122 | Bottom Plate Surface |
| 124, 124A, 124B | Dispenser Fasteners |
| 126 | Dispenser Fastener Aperture |
| 128 | Electrical Plate Aperture |
| 130 | Plate Length |
| 132 | Plate Width |
| 134 | Plate Thickness |
| 136 | Lid Mount Aperture Locations |
| 136L | Lid Mount Aperture Location Length |
| 136W | Lid Mount Aperture Location Width |
| 138 | Lid Mount Aperture Bore Diameter |
| 140 | Dispenser Aperture Locations |
| 140L | Dispenser Aperture Location Length |
| 140W | Dispenser Aperture Location Width |
| 142 | Dispenser Fastener Bore Diameter |
| 144 | Electrical Aperture Location |
| 144L, 144L_1, 144L_2, | Electrical Aperture Location Length |
| 144W, 144W_1, 144W_2 | Electrical Aperture Location Width |
| 146 | Electrical Aperture Corner Dimension |
| 148 | Boundary |
| 150 | Rim or Ring |
| 152 | Top Lid Surface |
| 154 | Top Ring Surface |
| 156 | Electrical Lid Aperture |
| 158 | Enclosure Cavity |
| 159 | Sidewall |
| 160 | Lid Fastener |
| 162 | Lid Aperture |
| 164 | Combined Top Surface |
| 166 | Periphery Apertures |
| 168 | Raised Surface or Protrusion |
| 170 | Lowered Surface or Recess |
| 172 | Control System |
| 174 | Electrical Component |
| 176 | Control Units |
| 178 | Processors |
| 180 | Memory |
| 182 | Program Instructions |
| 184 | User Interface |
| 186 | Displays |
| 188 | User Input Devices |
| 190 | Connector Ports |
| 192 | Sensors |
| 194 | Transmitters/Receivers |
| 200 | Method or process |
| 202, 204, 206 | Step |
| 210 | Method or process |
| 212, 214, 216, 218, 220 | Step |
| 300 | System |
| 302A, 302B | Configuration |
| 304A, 304B | Apertures |

### DETAILED DESCRIPTION

The present disclosure generally relates to a system and method for installing charging dispensers for an EV. In particular, the present disclosure relates to a dispenser anchor plate and methods for installing the same, where the anchor plate allows for the coupling of different charging dispenser configurations to a surface.

Embodiments of the present disclosure are directed to an anchor plate configured to couple to a base, to a support structure, or to a lid or cap of a utility box. Embodiments of the present disclosure are also directed to the anchor plate corresponding to a particular dispenser mounting configuration. Embodiments of the present disclosure are also directed to the anchor plate being operably or removably interconnected and/or swappable and/or interchangeable with another anchor plate having a different dispenser mounting configuration, where a corresponding charging dispenser is installed or swapped or interchanged with a charging dispenser with a different dispenser mounting configuration.

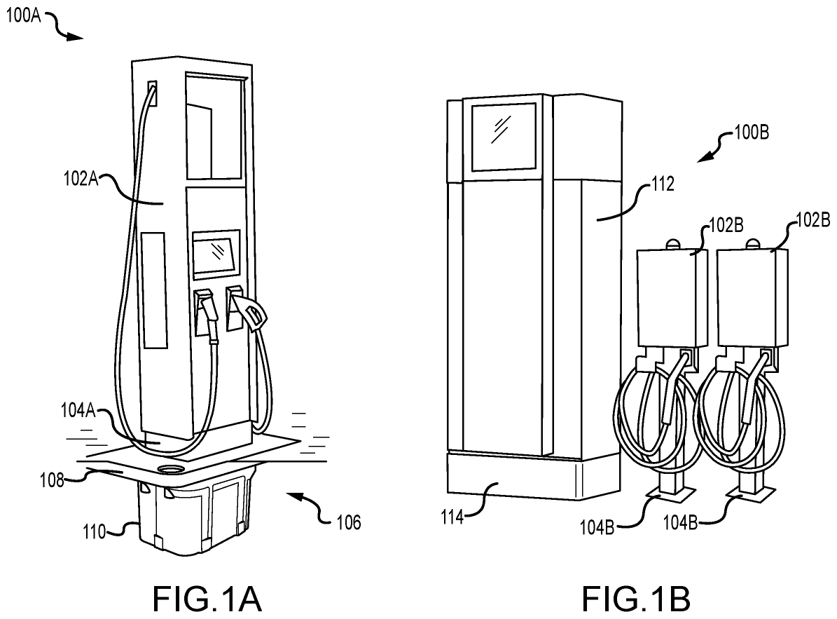

FIGS. 1A and 1B in general depict systems 100A, 100B including a charging dispenser 102A, 102B respectively sitting on a ground surface at a site location where the EV charging infrastructure is to be expanded or retrofitted, in accordance with embodiments of the present disclosure.

In FIG. 1A, the system 100A includes a charging dispenser 102A, which is a self-contained charging station. The charging dispenser 102A includes a dispenser base 104A that is operably or removably interconnected to a utility box 106. The utility box 106 includes a lid or cap 108 and an enclosure 110, and the lid 108 is operably or removably interconnected to the enclosure 110. The utility box 106 may be positioned or inserted in a hole within or proximate to a ground surface (e.g., be below grade) or, more generally, be at least partially buried in the ground. For example, a portion of the enclosure 110 and the entire lid 108 may be exposed above the ground, and a portion of the enclosure 110 may be buried or otherwise positioned in the ground. By way of another example, a portion of the lid 108 may be exposed above the ground, and a portion of the lid 108 and the entire enclosure 110 may be buried or otherwise positioned within the ground. By way of another example, a top surface of the lid 108 may be exposed (e.g., the top surface is flush to grade or below grade), with the remainder of the lid 108 and the entire enclosure 110 being buried or otherwise positioned within the ground. In this regard, the utility box 106 may be installed as necessary at the site location where the EV charging infrastructure is to be expanded or retrofitted.

For purposes of the present disclosure, a first system 100 component being “operably or removably interconnected” means to be positionable on or positionable in a second system 100 component at a particular location relative to the second system 100 component, and also able to be disconnected or otherwise removed from the location. In some instances, the first system 100 component may engage with or be couplable to the second system 100 component at or proximate to the particular location, such as being attached or affixed to the second system 100 component at or proximate to the particular location.

In FIG. 1B, the system 100B includes a charging dispenser 102B with a dispenser base 104B. The charging dispenser 102B is a peripheral device to a central power block 112 with a power block base 114. The central power block 112 includes control unit components to distribute power to and monitor the charging dispensers 102B. As the charging dispenser 102B is a peripheral device without all the power storage or control unit components as compared to the self-contained charging dispenser 102A, the dispenser base 104B may be smaller or more pedestal-like. The dispenser base 104B and/or the power block base 114 may couple to a utility box 106 in a similar manner as the dispenser base 104A couples to the utility box 106, as described in further detail herein.

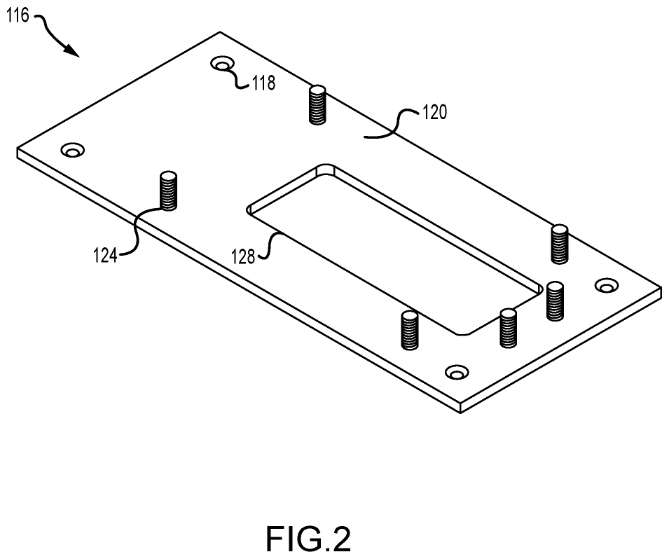

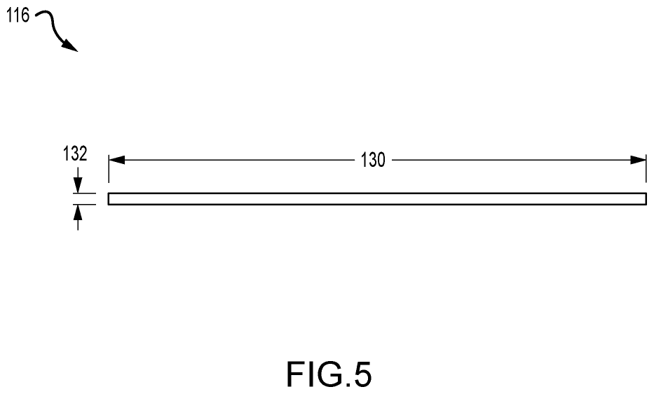

FIGS. 2-5 in general depict an example embodiment of a dispenser anchor plate 116, in accordance with one or more embodiments of the present disclosure. In some embodiments, the anchor plate 116 is a separate component couplable to the utility box 106. In other embodiments, the anchor plate 116 is a component of the utility box 106 or a component of the charging dispenser 102.

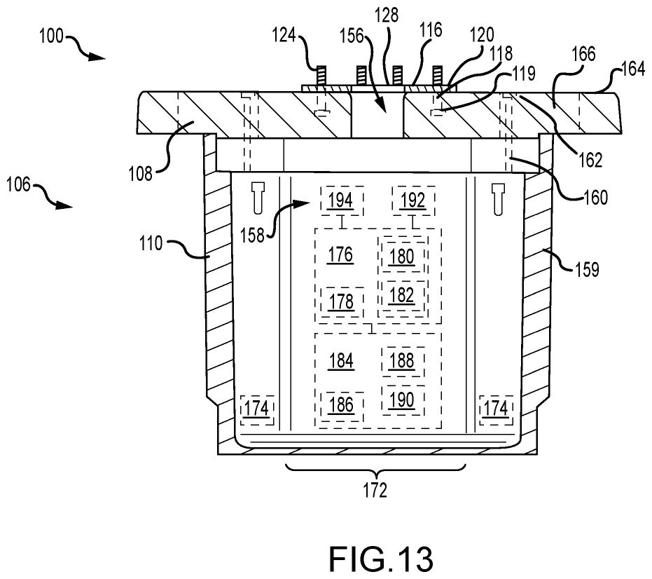

The anchor plate 116 includes one or more lid mount apertures 118. The one or more lid mount apertures 118 are configured to receive lid mount fasteners 119 (e.g., as depicted in FIG. 13) or other components of an interlocking assembly configured to secure the anchor plate 116 to the lid 108. The one or more lid mount apertures 118 may be flush or may be countersunk in a top plate surface 120 and/or a bottom plate surface 122.

For example, the one or more lid mount fasteners may enter the top plate surface 120 of the anchor plate 116, pass through the one or more lid mount apertures 118, and exit through the bottom plate surface 122 of the anchor plate 116 prior to engaging the lid 108 (e.g., threading into or otherwise interlocking with the lid 108). In some embodiments, the lid 108 includes integrated interlocking components (e.g., threading or other interlocking component) configured to engage the one or more lid mount fasteners 119. In addition, interlocking components (e.g., a nut or other interlocking component) may be positioned proximate to where the one or more lid mount fasteners 119 engage the lid 108, and be configured to couple with the one or more lid mount fasteners 119.

By way of another example, the one or more lid mount fasteners 119 may be coupled to the lid 108 and configured to enter the bottom plate surface 122, through the one or more lid mount apertures 118, and exit through the top plate surface 120. In this regard, interlocking components (e.g., a nut or other interlocking component) may be positioned proximate to where the one or more lid mount fasteners 119 exit the top plate surface 120, and be configured to couple with the one or more lid mount fasteners 119.

The anchor plate 116 includes one or more dispenser fasteners 124. For example, the one or more dispenser fasteners 124 may include a threaded bolt or other rod capable of interlocking (e.g., threading, or the like) with a corresponding component within the charging dispenser 102. In some embodiments, the one or more dispenser fasteners 124 may be affixed (e.g., welded, glued, molded therein, held in place by additional fasteners or brackets, or the like) to the anchor plate 116 to prevent movement when the charging dispenser 102 is coupled to the anchor plate 116. In some embodiments, the one or more dispenser fasteners 124 pass through the anchor plate 116 prior to being affixed to the anchor plate 116. For example, the one or more dispenser fasteners 124 may enter the anchor plate 116 through the bottom plate surface 122, pass through a dispenser fastener aperture 126 through the anchor plate 116, and exit the anchor plate 116 through the top plate surface 120. Thus, the dispenser fasteners 124 may not be permanently affixed (welded, glued, or molded herein) to the anchor plate 116 in these embodiments, being held in place with components such as additional fasteners or brackets. However, it should be understood the dispenser fasteners 124 could be permanently affixed (welded, glued, or molded herein) to the anchor plate 116.

In other embodiments, one or more dispenser fastener apertures 126 operable to receive the one or more dispenser fasteners 124 may be flush or may be countersunk in the bottom plate surface 122 and/or the top plate surface 120. It is noted, however, that the one or more dispenser fasteners 124 may be affixed (e.g., welded, glued, molded therein, held in place by additional fasteners, or the like) to the top plate surface 120 without first passing through the anchor plate 116. In these embodiments, the anchor plate 116 does not include the one or more dispenser fastener apertures 126.

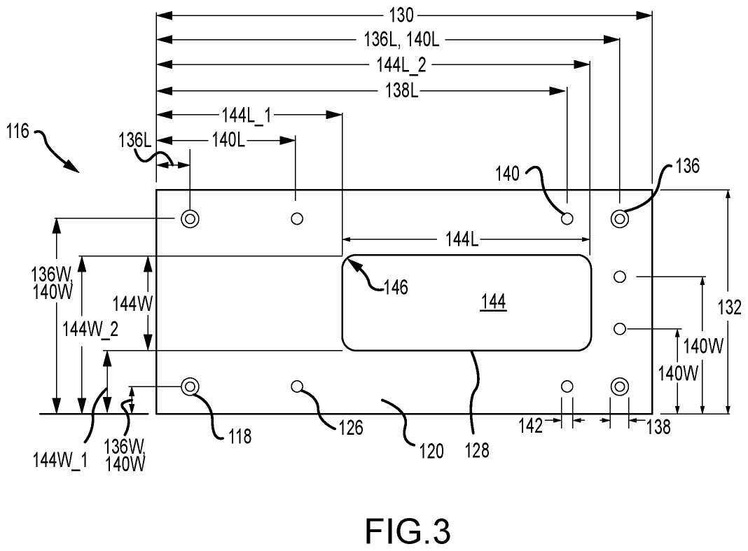

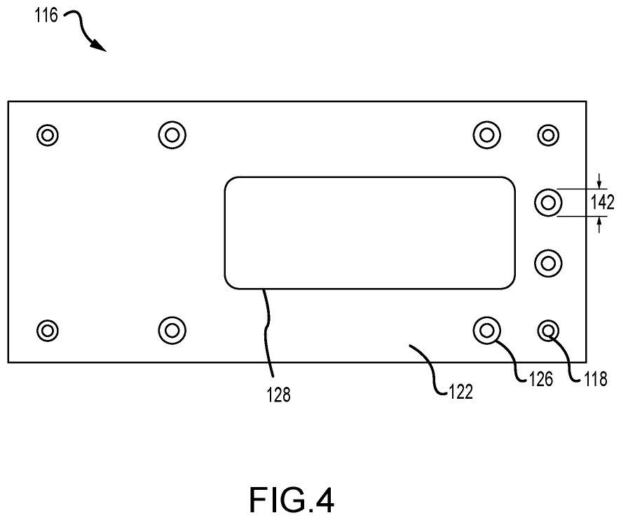

The anchor plate 116 is depicted with dispenser fasteners 124 which correspond to a particular charging dispenser 102 mounting configuration or mounting pattern or arrangement. It should be understood this is not limiting, and that the dispenser fasteners 124 (and the dispenser fastener apertures 126, when present on the anchor plate 116) may be based on any mounting configuration or mounting pattern or arrangement on the anchor plate 116 as may be necessary to mate with a charging dispenser configuration, to the extent the configuration does not interfere with the one or more lid mount apertures 118 and fasteners. In this regard, the anchor plate 116 may be configured for any number of charging dispensers 102, allowing for the installation of a different charging dispenser 102 on a utility box 106 and/or retrofitting of the same utility box 106 for a different charging dispenser 102, with the swapping or interchanging or replacing of the anchor plate 116 for a differently configured anchor plate 116. Thus, additional apertures 118, 126 may be present to permit dispenser fasteners 124 to be added to the anchor plate 116. It is noted that FIGS. 3 and 4 are depicted without the dispenser fasteners 124 as described through the present disclosure for purposes of clarity.

The anchor plate 116 includes one or more electrical plate apertures 128. For example, the one or more electrical plate apertures 128 allow for the routing of electrical components (e.g., electrical wires, conduit, connectors, or the like) from a cavity defined within the utility box 106 (e.g., within the enclosure 110) to the charging dispenser 102, as described in further detail herein.

Referring now to FIGS. 3-5 dimensions of the anchor plate 116 include a plate length 130, a plate width 132, and a plate thickness 134. In some embodiments, the dimensions define lid mount aperture locations 136. A location 136 may be defined as being positioned a length 136L amount of the plate length 130 measured from the left edge, and a width 136W amount of the plate width 132 measured from the front edge. In other embodiments, the dimensions include a lid mount fastener bore diameter 138.

In other embodiments, the dimensions define dispenser aperture locations 140. A location 140 may be defined as being positioned a length 140L amount of the plate length 130 measured from the left edge as shown in FIG. 3, and a width 140W amount of the plate width 132 measured from the front edge (i.e., the bottom edge in FIG. 3). In other embodiments, the dimensions include a dispenser fastener bore diameter 142.

In other embodiments, the dimensions define electrical aperture locations 144. A location 144 may have a length 144L defined as a difference between a length 144L_1 and a length 144L_2 of the plate length 130 measured from the left edge, and a width 144W defined a difference between a width 144W_1 and a width 144W_2 of the plate width 132 measured from the front edge. In other embodiments, the dimensions include an electrical aperture corner dimension 146. For example, the corner may have a select radius or a select angle between adjacent length and width edges of the electrical plate aperture 128.

In FIGS. 3-5, select locations 136, 140 have similar or the same length 136L, 140L and/or similar or the same width 136W, 140W, due to the mounting configuration of a particular charging dispenser 102 for which the anchor plate 116 is fabricated. The above should not be interpreted as limiting, however, as the dimensions of the anchor plate 116 may be any dimensions allowing for the anchor plate 116 to couple to the lid 108 and the charging dispenser 102.

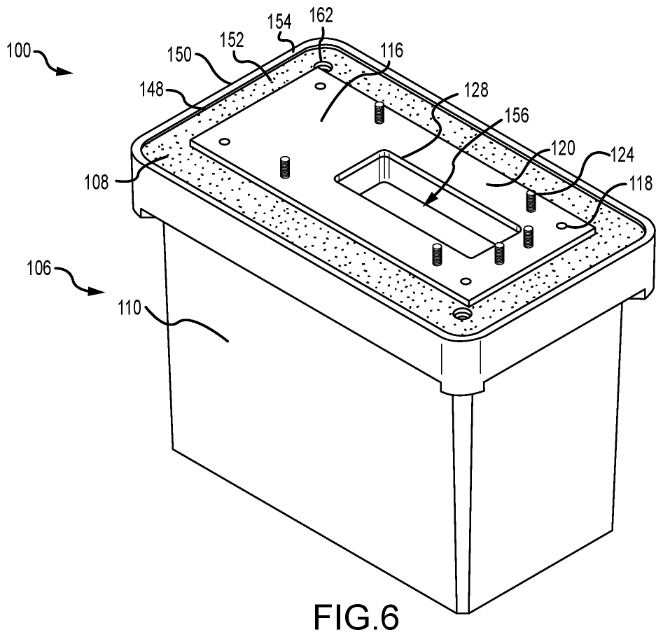

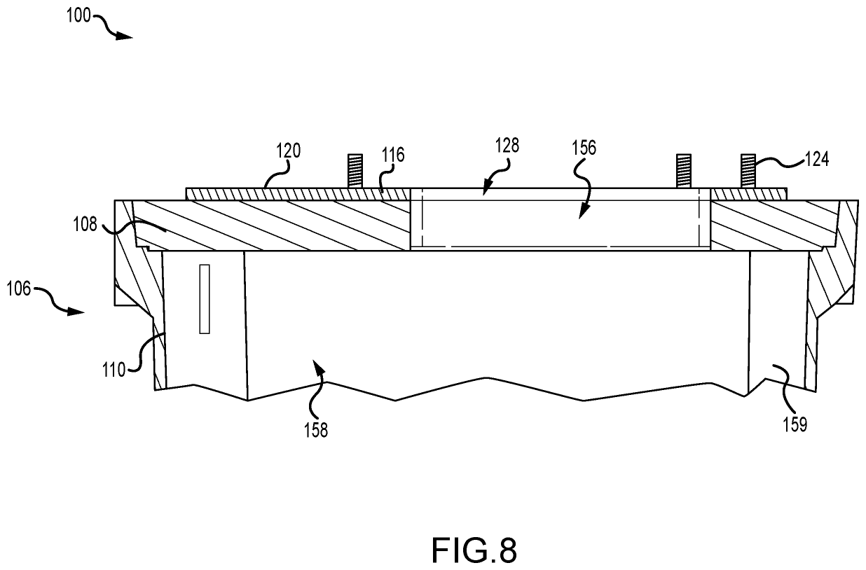

FIGS. 6-8 in general depict an example embodiment of the utility box 106 and the anchor plate 116, in accordance with one or more embodiments of the present disclosure. It is noted that the embodiments depicted in FIGS. 2-5 may be applicable to and/or combinable with FIGS. 6-8 unless otherwise stated, and vice versa.

In FIGS. 6-8, the lid 108 fits within a boundary 148 defined by a rim or ring 150 of the enclosure 110. In this regard, the length or width of the enclosure 110 is greater than a length or width of the lid 108.

In some embodiment, the lid 108 is seated flush within the enclosure 110, with a top lid surface 152 of the lid 108 and a top ring surface 154 of the ring 150 being substantially co-planar. The utility box 106 may be buried within the ground such that the top lid surface 152 and the top ring surface 154 of the ring 150 are flush with the ground (e.g., to grade). In other embodiments, the top lid surface 152 and/or the top ring surface 154 can be positioned above grade or below grade, with at least a portion of the lid 108 protruding above the ring 150, such that the top lid surface 152 and the top ring surface 154 are defined by different horizontal planes where one plane is higher relative to the ground than another plane.

As illustrated in FIGS. 6-8, in some embodiments the anchor plate 116 is raised above the lid 108, such that the top lid surface 152 and the top plate surface 120 are defined by different horizontal planes where one plane is higher relative to the ground than another plane. In other embodiments, the lid 108 may be configured with a cavity or recess that receives the anchor plate 116, such that the anchor plate 116 is positionable within the lid 108. Here, the top lid surface 152 and the top plate surface 120 are substantially co-planar.

The lid 108 includes an electrical lid aperture 156 configured to allow for the routing of electrical components (e.g., electrical wires, conduit, connectors, or the like) from an enclosure cavity 158 at least partially defined within a plurality of sidewalls 159 of the enclosure 110 to the charging dispenser 102. For example, the electrical plate aperture 128 at least partially aligns with or overlap the electrical lid aperture 156 when the anchor plate 116 is coupled to the lid 108. The enclosure cavity 158 may be contained within a solid-body enclosure with only an opening coverable by the lid 108, or may include one or more additional apertures configured to allow access (e.g., sub-grade access) into the enclosure cavity 158. The electrical lid aperture 156 may be considered an electrical base aperture 156, where the lid 108 is a base 108, for purposes of the present disclosure.

The electrical plate aperture 128 and/or the electrical lid aperture 156 may generally be any shape known in the art. For example, the electrical plate aperture 128 and/or the electrical lid aperture 156 may be a rectangle, a rounded rectangle, a circle, an oval, an ellipse, or other known polygonal shape extending through the thickness of the anchor plate 116 and/or the lid 108, respectively. The electrical plate aperture 128 and the electrical lid aperture 156 can be the same shape and/or size in some embodiments, or can be a different shape and/or size in other embodiments.

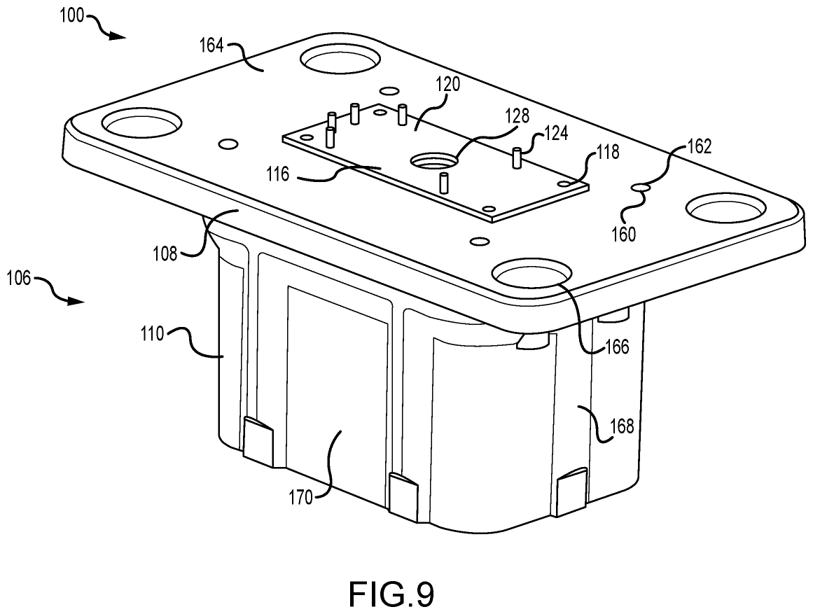

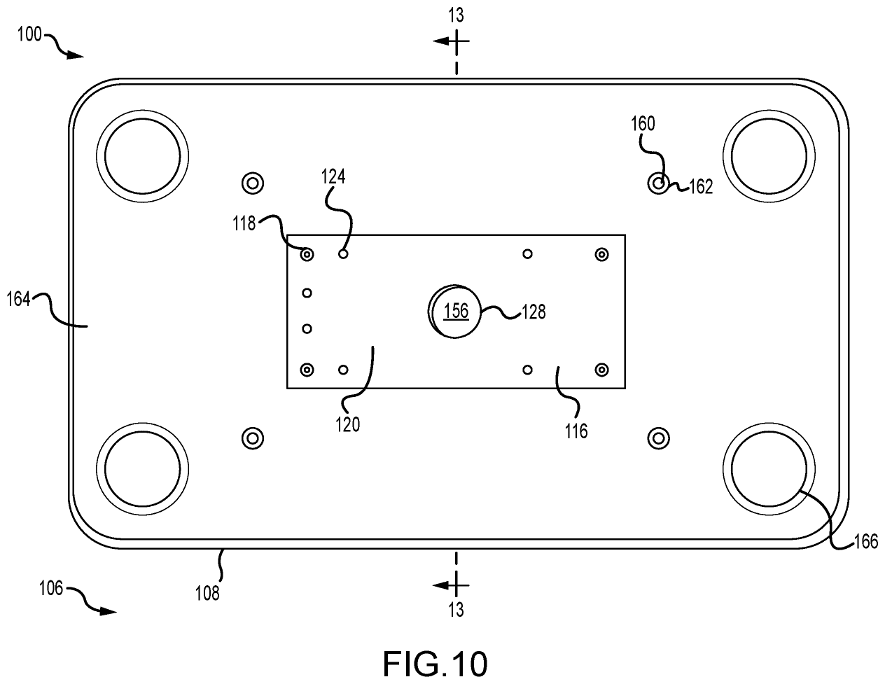

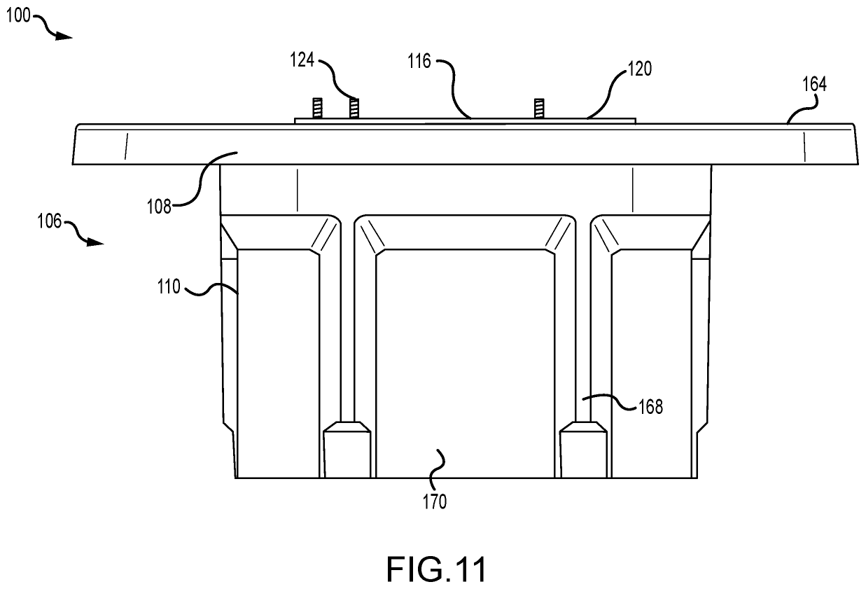

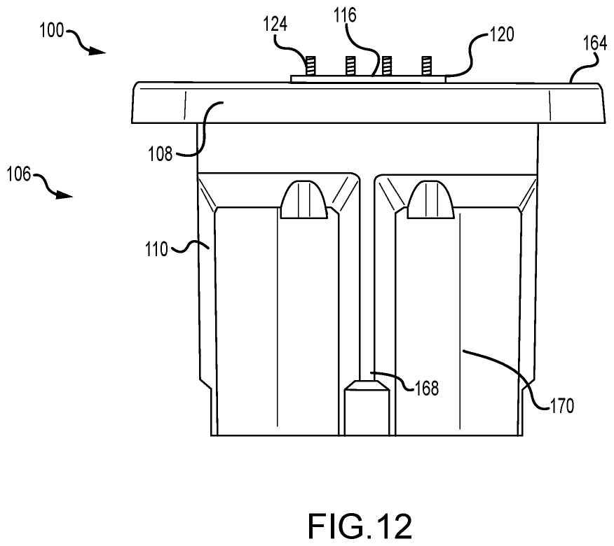

The lid 108 couples to the enclosure 110 via one or more lid fasteners 160 or components of an interlocking assembly within one or more corresponding lid apertures 162 (e.g., as depicted in FIGS. 9-13). The one or more lid fasteners 160 or components of an interlocking assembly may cause the lid 108 to engage the enclosure 110, preventing the removal of the lid 108 from the enclosure 110 absent an external force (e.g., applied via hand, via a tool, or the like). In this regard, an enclosure cavity 158 and the electrical components within that are coupled to the charging dispenser 102 may be protected from unauthorized access. In addition, the one or more lid fasteners 160 or components of an interlocking assembly may assist in securing the lid 108 (and thus the charging dispenser 102 via the anchor plate 116), reducing the possibility the charging dispenser 102 is knocked over or otherwise unseated from the utility box 106. The lid 108 may be configured to interlock with portions of the enclosure 110 including, but not limited to, one or more sidewalls at least partially defining the enclosure cavity 158.

FIGS. 9-13 in general depict another example embodiment of the utility box 106 and the anchor plate 116, in accordance with one or more embodiments of the present disclosure. It is noted that the embodiments depicted in FIGS. 2-5 may be applicable to and/or combinable with FIGS. 9-13 unless otherwise stated, and vice versa. In addition, it is noted that the embodiments in FIGS. 6-8 may be applicable to and/or combinable with FIGS. 9-13 unless otherwise stated, and vice versa.

In FIGS. 9-13, the lid 108 has an increased length and width as compared to a length and width of the enclosure 110. Here, the ring 150 may be a component of the lid 108 instead of the enclosure 110 as depicted in FIGS. 6-8, such that the top surfaces 152, 154 of FIGS. 6-8 are instead a combined top surface 164 of the lid 108. The lid 108 may include one or more periphery apertures 166, which pass through the thickness 134 of the lid 108 at locations exterior to and surrounding the location of the enclosure 110.

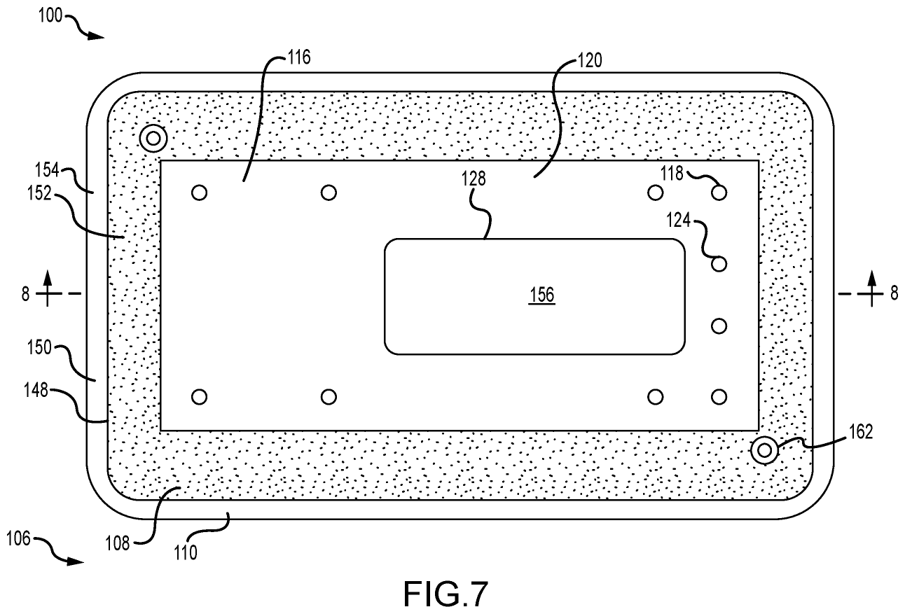

In some embodiments, the enclosure 110 include one or more raised surfaces or protrusions 168 on the plurality of sidewalls of the enclosure 110, and/or include one or more lowered surfaces or recesses 170 set within the plurality of sidewalls of the enclosure 110. For example, the protrusions 168 and/or recesses 170 may interface with or otherwise position and hold the enclosure 110 (and thus the utility box 106) in place within the ground. By way of another example, the protrusions 168 and/or recesses 170 may provide additional rigidity or support to the enclosure 110 (and thus the utility box 106). In other embodiments, the vertical or angled sides of the enclosure 110 may be planar or substantially planar (e.g., as depicted in FIGS. 6 and 7).

As illustrated in FIGS. 9-13, in some embodiments the anchor plate 116 is raised above the lid 108, such that the combined top surface 164 and the top plate surface 120 are defined by different horizontal planes where one plane is higher relative to the ground than another plane. In other embodiments, the lid 108 may be configured with a cavity or recess that receives the anchor plate 116, such that the anchor plate 116 is positionable within the lid 108. Here, the combined top surface 164 and the top plate surface 120 are co-planar.

The lid 108 and/or the enclosure 110 may be fabricated from a polymer concrete formed from graded aggregate and polyester resin and reinforced with fiberglass mat. Other example material for the lid 108 and/or the enclosure 110 are described in the patents and patent applications incorporated by reference herein and throughout the present disclosure. In addition, example designs for the lid 108 and/or the enclosure 110 are generally described in the patents and patent applications incorporated by reference herein and throughout the present disclosure.

The anchor plate 116 as described throughout the present disclosure may be fabricated from a metal as determined by end user requirements (e.g., corresponding to a particular charging dispenser 102 mounting configuration). For example, the anchor plate 116 may be cut, stamped, CNC milled, or otherwise machined to meet end user requirements. The anchor plate 116 may be protected from deterioration with the use of a select fabrication material or the application of a coating (e.g., galvanized, coated with a protectant material, or the like).

In embodiments, the utility box 106 of the present disclosure may be configured to house components of a control system 172 and/or electrical components 174 for the charging dispenser 102 (e.g., as illustrated in FIG. 13). The components of the control system 172 and/or the electrical components 174 may be coupled to the charging dispenser 102 via wired connections through the electrical plate aperture 128 and/or the electrical lid aperture 156, and/or via wireless connections.

The control system 172 may include one or more control units 176 (e.g., a controller, server, or the like). The one or more control units 176 may include processors 178 and memory 180 (e.g., a memory medium, memory device, or the like). The processors 178 may be configured to execute program instructions 182 maintained on or stored in the memory 180. The processor of the one or more control units 176 may execute any of the various method or process steps necessary to operate the charging dispenser 102.

The control system 172 may include a user interface 184 coupled (e.g., physically coupled, electrically coupled, communicatively coupled, or the like) to the one or more control units 176. For example, the user interface 184 may be a separate device coupled to the one or more control units 176. By way of another example, the user interface 184 and the one or more control units 176 may be located within a common or shared housing. The user interface 184 may include one or more displays 186, one or more user input devices 188, and/or one or more port connectors 190 (e.g., for the transmitting and/or receiving of power and/or data, and the like).

The control system 172 may include one or more sensors 192 coupled (e.g., physically coupled, electrically coupled, communicatively coupled, or the like) to or integrated in the one or more control units 176 and/or the charging dispenser 102. The one or more sensors 192 may be operable to determine various operational, physical, and/or environmental parameters of the charging dispenser 102, the utility box 106, the control system 172, the environment surrounding the charging dispenser 102, the utility box 106, and/or the control system 172, and the like. For instance, the sensors 192 may be operable to determine power output by the charging dispenser 102, temperature of the charging dispenser 102, the utility box 106, the control system 172, and/or the surrounding environment, and the like. The control system 172 may include one or more transmitters and/or receivers 194 coupled (e.g., physically coupled, electrically coupled, communicatively coupled, or the like) to or integrated in the one or more control units 176 and/or the charging dispenser 102. The one or more transmitters and/or receivers 194 may be configured to transmit data to and/or receive data from the charging dispenser 102 (e.g., from sensors installed within the charging dispenser 102) or from external third-party control units (e.g., controllers, servers, or the like) either via wired connections or wireless connections, which may be configured as transmitting (Tx) units, receiving (Rx) units, or combination Tx/Rx units.

The control system may be configured to monitor the charging dispenser 102 via received and/or transmitted data. The control system may be configured to generate control signals to adjust one or more components of the charging dispenser 102 via a feedback loop or a feed forward loop based on the received and/or transmitted data. The control system may be configured to receive and/or transmit data in a standardized format and/or a non-standardized format. Where the data is in a non-standardized format, the data may be converted to a standardized format upon receipt and/or prior to transmission to sensors, third-party control units, or the like.

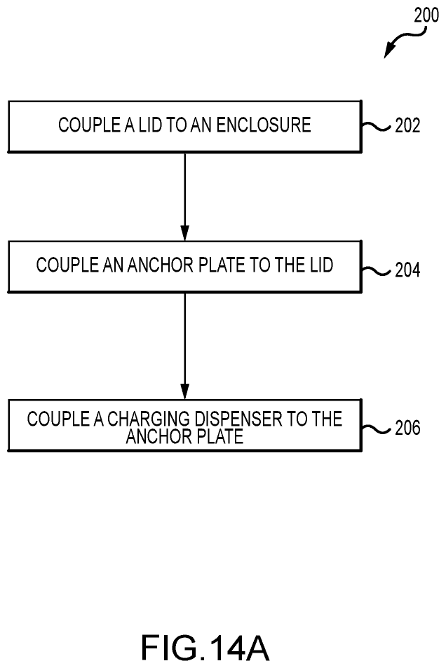

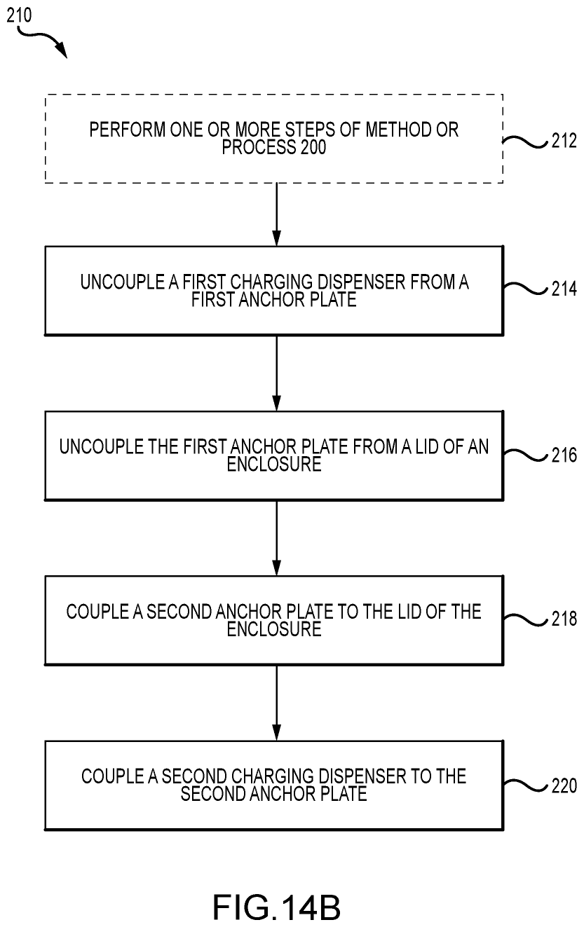

FIG. 14A illustrates a method or process 200 for installing components of the system 100, according to one or more embodiments of the present disclosure. In particular, the method or process 200 includes one or more of the following steps or embodiments. Any embodiment related to the charging dispenser 102, the utility box 106 with lid 108 and enclosure 110, the anchor plate 116, and/or other components of the system 100 as described throughout the present disclosure may be applicable to the following steps or embodiments.

In a step 202, a lid 108 is coupled to an enclosure 110. The lid 108 may be coupled to the enclosure 110 with the one or more lid fasteners 160 or components of an interlocking assembly. For example, the one or more lid fasteners 160 or components of an interlocking assembly may be locking or otherwise tamper-resistant. The lid apertures 162 may be counterbored to prevent the lid fasteners 160 from extending or protruding above the top surfaces 152, 164 of the lid 108 and interfering with the placement of an anchor plate 116 and/or a charging dispenser 102. Optionally, a gasket or other flexible, weather-resistant material may be inserted between the lid 108 and the enclosure 110 prior to coupling. In addition, the lid 108 and/or the enclosure 110 may optionally be fabricated with a gasket or other weather-resistant material at the interfacing or engaging locations between the lid 108 and the enclosure 110.

In a step 204, an anchor plate 116 is coupled to a lid 108 of the utility box 106. The lid 108 includes uniform locations to which any anchor plate 116 couples via lid mount fasteners 119 or other components of an interlocking assembly. The lid mount apertures 118 may be counterbored to prevent the lid mount fasteners 119 from extending or protruding above the top plate surface 120 and interfering with the placement of a charging dispenser 102. Optionally, a gasket or other flexible, weather-resistant material may be inserted between the anchor plate 116 and the lid 108 prior to coupling. In addition, the anchor plate 116 and/or the lid 108 may optionally be fabricated with a gasket or other flexible, weather-resistant material at the interfacing or engaging locations between the anchor plate 116 and the lid 108.

In a step 206, a charging dispenser is coupled to the anchor plate 116. The anchor plate 116 may include dispenser fasteners 124 or other components of an interlocking assembly which correspond to a particular charging dispenser 102 mounting configuration or mounting pattern. In this regard, the anchor plate 116 may be specific to one charging dispenser 102 (or specific to any of a set of charging dispensers 102 with similar configurations). Optionally, a gasket or other flexible, weather-resistant material may be inserted between the charging dispenser 102 and the anchor plate 116, and/or the charging dispenser 102 and the lid 108, prior to coupling. In addition, the charging dispenser 102, the anchor plate 116, and/or the lid 108 may optionally be fabricated with a gasket or other flexible, weather-resistant material at the interfacing or engaging locations between the charging dispenser 102 and the anchor plate 116, and/or the charging dispenser 102 and the lid 108.

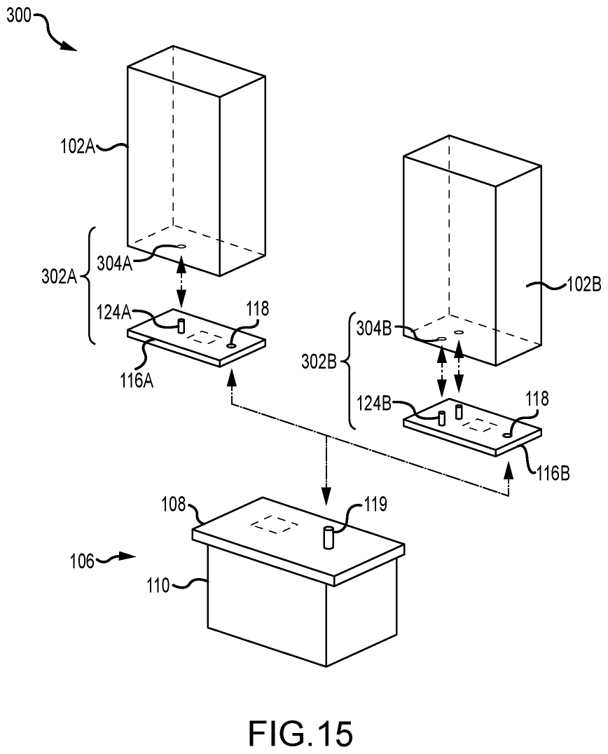

FIG. 14B illustrates a method or process 210 for swapping or interchanging components of the system 100, according to one or more embodiments of the present disclosure. In particular, the method or process 210 includes one or more of the following steps or embodiments. Any embodiment related to the charging dispenser 102, the utility box 106 with lid 108 and enclosure 110, the anchor plate 116, and/or other components of the system 100 as described throughout the present disclosure may be applicable to the following steps or embodiments. FIG. 15 illustrates a system 300 for swapping or interchanging components of the system 100, according to one or more embodiments of the present disclosure. Embodiments directed to the system 100 are also applicable to and/or combinable with embodiments of the system 300, and vice versa, unless otherwise noted. FIGS. 14B and 15 are discussed together herein.

In an optional step 212, one or more steps of the method or process 200 are performed. For example, the one or more steps of the method or process 200 may be prior to the one or more steps of the method or process 210, such that an existing first charging dispenser 102A is already installed at the site location for the remainder of the method or process 210.

In a step 214, and as illustrated in FIG. 15, the first charging dispenser 102A is uncoupled from a first anchor plate 116A, where the first charging dispenser 102A has a first configuration including an aperture or apertures 304A which corresponds to a first configuration 302A of a dispenser fasteners or fasteners 124A of the first anchor plate 116A. Optionally, where a gasket or other flexible, weather-resistant material is inserted between the first charging dispenser 102A and the first anchor plate 116A, the gasket or other flexible, weather-resistant material may be removed after uncoupling.

In a step 216, and as illustrated in FIG. 15, the first anchor plate 116A is uncoupled from a lid 108 of a utility box 106. Optionally, where a gasket or other flexible, weather-resistant material is inserted between the first anchor plate 116A and the lid 108, the gasket or other flexible, weather-resistant material may be removed after uncoupling.

In a step 218, and as illustrated in FIG. 15, a second anchor plate 116B is coupled to the lid 108, where the second anchor plate 116B has a different configuration 302B for a dispenser fastener or fasteners 124B from the first anchor plate 116A. The interchangeability of the plates 116A, 116B is due to the uniform locations of the lid mount apertures 118 on all anchor plates 116 and the lid mount fasteners 119 on the lid 108. Optionally, a gasket or other flexible, weather-resistant material may be inserted between the second anchor plate 116B and the lid 108 prior to coupling. In addition, the second anchor plate 116B and/or the lid 108 may optionally be fabricated with a gasket or other flexible, weather-resistant material at the interfacing or engaging locations between the second anchor plate 116B and the lid 108.

In a step 220, and as illustrated in FIG. 15, a second charging dispenser 102B is coupled to the second anchor plate 116B, where the second charging dispenser 102B has a second different configuration from the first charging dispenser 102A, where the second different configuration includes an aperture or apertures 304B that corresponds to the second configuration 302B of the dispenser fastener or fasteners 124B on the second anchor plate 116B. Optionally, a gasket or other flexible, weather-resistant material may be inserted between the second charging dispenser 102B and the second anchor plate 116B prior to coupling. In addition, the second charging dispenser 102B and/or the lid 108 may optionally be fabricated with a gasket or other flexible, weather-resistant material at the interfacing or engaging locations between the second charging dispenser 102B and the lid 108.

In alternative embodiments to the steps provided above, the second anchor plate 116B may be coupled to the first anchor plate 116A to modify the first anchor plate 116A to include a second mounting pattern for the second charging dispenser 102B, such that the first anchor plate 116A as modified with the second mounting pattern can couple to the second charging dispenser 102B without removal of the first anchor plate 116A. In these embodiments, the second anchor plate 116B may include both the first mounting pattern or mounting configuration 302A to couple to the first anchor plate 116A and the second mounting pattern or mounting configuration 302B to couple to the second charging dispenser 102B, in addition to or instead of coupling the second anchor plate 116B to the lid 108.

In additional steps, electrical components may be routed through electrical plate apertures 128, 156 in the lid 108 and/or the anchor plate 116 simultaneously, substantially simultaneously, or sequentially with any of the steps of the methods of processes 200, 210 described herein.

Any methods described throughout the disclosure may include more or fewer steps or embodiments than those described. In addition, the steps or embodiments of any methods may be performed at any time (e.g., sequentially, concurrently, or simultaneously). Further, the steps or embodiments of any methods may be performed in any order, including in an order as presented in the disclosure and/or an order other than that presented in the disclosure. It should be understood that the methods or processes 200, 210 may include any manufacturing or fabrication steps and/or ground surface preparation steps that occur prior to the combining of the components of the system 100, without departing from the scope of the present disclosure. For example, the methods or processes 200, 210 may include, but are not limited to, steps related to fabricating the utility box 106 including the lid 108 and/or the enclosure 110, and/or fabricating the anchor plates 116. By way of another example, the method or processes 200, 210 may include, but are not limited to steps related to preparation of a ground surface including digging or excavating, planing, running of electrical components to the worksite and/or the charging dispenser installation site, and the like prior to installation of the utility box 106 and/or its components.

Although embodiments of the present disclosure depict the anchor plate 116 being operably or removably interconnected to the lid 108 of the utility box 106, the anchor plate 116 may be integrated with a design of the lid 108, as the lid 108 is itself operably or removably interconnected or operably interconnected to the enclosure 110 of the utility box 106 as described throughout the present disclosure. In this regard, the lid 108 may be interchangeable or swappable and configurable with a particular charging dispenser 102 design or mounting configuration. Designing the lid 108 to be interchangeable and configurable with the charging dispenser 102 may remove the need for the additional anchor plate 116, decreasing the complexity of the system 100 and the cost to fabricate the utility box 106 and/or implement the utility box 106 and the anchor plate 116 with a charging dispenser 102.

Although embodiments of the present disclosure depict the anchor plate 116 being operably or removably interconnected or operably interconnected to the lid 108 of the utility box 106, the lid 108 may instead be a base or support structure 108 to which the anchor plate 116 may be operably or removably interconnected or operably interconnected. The base or support structure 108 may directly anchor to the ground surface (e.g., via anchoring mechanisms), and electrical connections for the charging dispenser 102 may be routed underneath the base or support structures 108 may through apertures 128, 156 in the anchor plate 116 or the base or support structure 108, respectively. In this regard, the base or support structure 108 may be a slab or other structure that does not couple to the enclosure 110, and as such may not be a component of the utility box 106, decreasing the complexity of the system 100 and the cost to fabricate the base or support structure 108 and/or implement the base or support structure 108 and the anchor plate 116 with a charging dispenser 102. It is noted that any embodiments generally directed to the lid or cap 108 may be directed to the base or support structure 108, and that any embodiments generally directed to the charging dispenser 102 may be directed to the apparatus 102, without departing from the scope of the present disclosure.

Advantages of the present disclosure are directed to an anchor plate configured to couple to a base, to a support structure, or to a lid or cap of a utility box. Advantages of the present disclosure are also directed to the anchor plate corresponding to a particular dispenser mounting configuration. Advantages of the present disclosure are also directed to the anchor plate being operably or removably interconnected and/or swappable or interchangeable with another anchor plate having a different configuration, where a corresponding charging dispenser is installed or swapped with a charging dispenser with a different configuration.

In this regard, the present disclosure provides a uniform solution for designing an increasingly modular or retrofittable EV charging infrastructure. Each anchor plate 116 is configured for a particular charging dispenser 102 mounting configuration or mounting pattern and is uniform to any lid 108, which allows for an increased ease when swapping charging dispensers 102 as they fail, become obsolete, or are otherwise in need of replacement. In addition, using the utility boxes 106 with the charging dispensers 102 allows for increased ease of retrofitting and broadening of EV charging infrastructure with minimal downtime or construction costs. Removal of the lid 108 (and the attached charging dispenser 102) from the enclosure 110 allows for the maintenance of components housed within the enclosure 110 (e.g., electrical connections and/or mounting hardware for the charging dispenser 102, or the like) without having to excavate the entire utility box 106. In this regard, the anchor plate 116 combined with the lid 108 (and the utility box 106 in general) reduces or eliminates the need for excavating old mounting structures for old charging dispensers and modifying the ground surface to accept new mounting structures for new charging dispensers, thus reducing time and expenses.

Although embodiments of the present disclosure depict the anchor plate 116 and utility box 106 being in use with the charging dispenser 102, it is noted the anchor plate 116 and utility box 106 may be configured for use with EV charging stations, ATMs, gas pumps, drive-thru signs and terminals, parking lot ticket kiosks, toll booths, bike or scooter rental kiosks, residential and commercial fixtures such as light poles, bollards, barriers, or cones, and generally any apparatus or device to which a person may walk, ride, or drive. In this regard, the embodiments of the present disclosure described with respect to the charging dispenser 102 should be considered illustrative and not be considered limiting. For example, any embodiments of component labelled “charging dispenser” may be understood as generally being an “apparatus” component.

While various embodiments of the system and method have been described in detail, it is apparent that modifications and alterations of those embodiments will occur to those skilled in the art. It is to be expressly understood that such modifications and alterations are within the scope and spirit of the present disclosure. Further, it is to be understood that the phraseology and terminology used herein is for the purposes of description and should not be regarded as limiting. The use of “including,” “comprising,” or “having” and variations thereof herein are meant to encompass the items listed thereafter and equivalents thereof, as well as, additional items. Further, it is to be understood that the claims are not necessarily limited to the specific features or steps described herein. Rather, the specific features and steps are disclosed as embodiments of implementing the claimed systems and methods.

What is claimed is:

1. A system for installing charging dispensers for an electric vehicle, the system comprising:
a utility box, comprising:
an enclosure including a plurality of sidewalls defining an enclosure cavity; and
a lid operably interconnected to the plurality of sidewalls and including a lid mount fastener,
wherein at least a portion of one or more of the enclosure and the lid is positioned within a ground surface; and
a first anchor plate, comprising:
a first lid mount aperture configured to receive the lid mount fastener, the first anchor plate being removably interconnected to the lid at a predetermined location on the lid when the first lid mount aperture receives the lid mount fastener; and
a first dispenser fastener at a location on the first anchor plate defined by a first mounting pattern of a first charging dispenser, wherein the first anchor plate is operable to interconnect with the first charging dispenser via the first dispenser fastener,
wherein the utility box is operable to interconnect the first charging dispenser to the ground surface via interconnection between the first anchor plate and the lid.

2. The system of claim 1, wherein the lid comprises an electrical lid aperture, wherein the first anchor plate comprises a first electrical plate aperture configured to at least partially overlap with the electrical lid aperture when the first charging dispenser is interconnected to the lid via the first anchor plate, and
wherein the electrical lid aperture and the first electrical plate aperture are configured to allow for routing of one or more electrical components between the enclosure cavity and the first charging dispenser when the first charging dispenser is interconnected to the lid via the first anchor plate.

3. The system of claim 1, further comprising:
a second anchor plate, comprising:
a second lid mount aperture configured to receive the lid mount fastener, the second anchor plate being removably interconnected to the lid at the predetermined location on the lid when the second lid mount aperture receives the lid mount fastener; and
a second dispenser fastener at a location defined by a second mounting pattern of a second charging dispenser, wherein the second anchor plate is operable to interconnect with the second charging dispenser via the second dispenser fastener,
wherein the second mounting pattern of the second charging dispenser is different from the first mounting pattern of the first charging dispenser, and
wherein the utility box is operable to interconnect the second charging dispenser to the ground surface via interconnection between the second anchor plate and the lid.

4. The system of claim 3, wherein the second anchor plate is removably interconnected with the lid at the predetermined location on the lid when the first anchor plate is not interconnected to the lid.

5. The system of claim 3, wherein the second anchor plate comprises a second electrical plate aperture configured to at least partially overlap with the electrical lid aperture when the second charging dispenser is interconnected to the lid via the second anchor plate, and
wherein the electrical lid aperture and the second electrical plate aperture are configured to allow for routing of one or more electrical components between the enclosure cavity and the second charging dispenser when the second charging dispenser is interconnected to the lid via the second anchor plate.

6. The system of claim 3, wherein the predetermined location for at least one of the first anchor plate and the second anchor plate is on a top surface of the lid.

7. The system of claim 6, wherein the top surface of the lid is a first planar surface, and wherein a top plate surface of at least one of the first anchor plate and the second anchor plate is a second planar surface at a different height relative to the ground surface than the first planar surface.

8. The system of claim 1, the lid further including at least one lid aperture configured to receive at least one lid fastener, the lid being removably interconnected to the enclosure via the interconnection of the at least one lid aperture, the at least one lid fastener, and the enclosure.

9. A method for installing charging dispensers for an electric vehicle, the method comprising:
coupling a first anchor plate to a lid of a utility box via a lid mount fastener of the lid at a predetermined location on the lid, the lid mount fastener configured to engage with a first lid mount aperture of the first anchor plate when interconnecting the first anchor plate to the lid, the lid being operably interconnected to a plurality of sidewalls defining an enclosure cavity of an enclosure of the utility box, wherein at least a portion of one or more of the enclosure and the lid is positioned within a ground surface; and
coupling a first charging dispenser to the first anchor plate via a first dispenser fastener of the first anchor plate positioned at a location on the first anchor plate defined by a first mounting pattern of the first charging dispenser,
wherein the utility box is operable to interconnect the first charging dispenser to the ground surface via interconnection between the first anchor plate and the lid.

10. The method of claim 9, further comprising:
when the first charging dispenser is interconnected to the lid via the first anchor plate, routing one or more electrical components from the enclosure cavity through an electrical lid aperture of the lid and a first electrical plate aperture of the first anchor plate configured to at least partially overlap with the electrical lid aperture.

11. The method of claim 9, further comprising:
coupling a second anchor plate to the lid via the lid mount fastener, the lid mount fastener configured to engage with a second lid mount aperture of the second anchor plate when interconnecting the second anchor plate to the lid; and
coupling a second charging dispenser to the second anchor plate via a second dispenser fastener of the second anchor plate positioned at a location on the second anchor plate defined by a second mounting pattern of the second charging dispenser,
wherein the second mounting pattern of the second charging dispenser is different from the first mounting pattern of the first charging dispenser, and
wherein the utility box is operable to interconnect the second charging dispenser to the ground surface via interconnection between the second anchor plate and the lid.

12. The method of claim 11, wherein the second anchor plate is removably interconnected with the lid at the predetermined location on the lid when the first anchor plate is not coupled to the lid, and wherein the first charging dispenser is uncoupled from the first anchor plate and the first anchor plate is uncoupled from the lid prior to the coupling of the second anchor plate to the lid and the coupling of the second charging dispenser to the second anchor plate.

13. The method of claim 11, further comprising:
when the second charging dispenser is interconnected to the lid via the second anchor plate, routing one or more electrical components from the enclosure cavity through an electrical lid aperture of the lid and a second electrical plate aperture of the second anchor plate configured to at least partially overlap with the electrical lid aperture.

14. The method of claim 11, wherein the predetermined location for at least one of the first anchor plate and the second anchor plate is on a top surface of the lid.

15. The method of claim 14, wherein the top surface of the lid is a first planar surface, and wherein a top plate surface of at least one of the first anchor plate and the second anchor plate is a second planar surface at a different height relative to the ground surface than the first planar surface.

16. An anchor plate for installing charging dispensers for an electric vehicle, the anchor plate comprising:
a lid mount aperture configured to receive a lid mount fastener, the anchor plate being removably interconnectable to a lid of a utility box at a predetermined location on the lid when the lid mount aperture receives the lid mount fastener; and
a dispenser fastener at a location on the anchor plate defined by a mounting pattern of a charging dispenser, wherein the anchor plate is operable to interconnect with the charging dispenser via the dispenser fastener,
wherein an interconnection between the anchor plate and the lid interconnects the charging dispenser to the utility box.

17. The anchor plate of claim 16, wherein the anchor plate is one of a plurality of interchangeable anchor plates, each of anchor plates in the plurality of interchangeable anchor plates including a mounting pattern for a particular charging dispenser, wherein the mounting pattern of the charging dispenser on the anchor plate is different from a second mounting pattern of a second charging dispenser on a second anchor plate of the plurality of interchangeable anchor plates.

18. The anchor plate of claim 16, wherein the anchor plate comprises an electrical plate aperture configured to at least partially overlap with an electrical lid aperture in the lid when the charging dispenser is interconnected to the lid to allow for routing of one or more electrical components between an enclosure cavity defined by a plurality of sidewalls of an enclosure of the utility box and the charging dispenser when the charging dispenser is interconnected to the lid via the anchor plate.

19. The anchor plate of claim 16, wherein the predetermined location for the anchor plate is on a top surface of the lid.

20. The anchor plate of claim 19, wherein the top surface of the lid is a first planar surface, and wherein a top plate surface of the anchor plate is a second planar surface at a different height relative to a ground surface than the first planar surface.
